(19) United States
(12) Patent Application Publication
(10) Pub. No.: US 2008/0038029 A1
(43) Pub. Date: Feb. 14, 2008

(54) DUPLEX SCANNING APPARATUS

(75) Inventors: Chung-Kai Wang, Taipei (TW); Chien-Kuo Kuan, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/532,310

(22) Filed: Sep. 15, 2006

(30) Foreign Application Priority Data
Aug. 10, 2006 (TW) 095129324

(51) Int. Cl. G03G 15/00

(52) U.S. Cl. 399/374

(57) ABSTRACT

A duplex scanning apparatus includes a sheet feeding tray, a sheet pick-up roller and a sheet separation roller. The sheet feeding tray includes a first opening and a second opening. The sheet pick-up roller and the sheet separation roller are partially received in the first opening and the second opening of the sheet feeding tray, respectively, so that the sheet pick-up roller and the sheet separation roller are sustained against documents on the sheet feeding tray. For performing duplex scanning operations on the stack of paper sheets, the documents are successively scanned from the bottommost paper sheet to the uppermost paper sheet. As a consequence, the scanned documents are stacked in the discharging tray in the same order as that of the original stack.

### FIELD OF THE INVENTION

The present invention relates to a duplex scanning apparatus, and more particularly to a duplex scanning apparatus for performing a two-pass scanning operation.

### BACKGROUND OF THE INVENTION

Image scanners are widely used for scanning images of documents, photographs or films. The scanned images can be converted into electronic files, and then stored or processed in a computer. With increasing development of scanning technologies, the image scanners have experienced great growth and are now rapidly gaining in popularity.

In the early stage, the image scanner can scan one side of the document. For scanning both sides of the document, after one side of the document has been scanned, the document should be manually turned over so as to scan the other side of the document. However, the process of manually turning over the document is troublesome. Recently, a duplex scanning apparatus was developed for automatically performing a duplex scanning operation to scan both sides of the document.

A typical duplex scanning apparatus usually comprises a flatbed image scanning portion and an automatic document feeder arranged above the flatbed image scanning portion. The flatbed image scanner portion is utilized to scan most documents regardless of a single sheet or a thick book. In a case that the thick book is scanned, the automatic document feeder is not feasible. For performing the duplex scanning operation, a stack of paper sheets are successively and continuously fed by the automatic document feeder to be transported through a scan region in the flatbed image scanning portion. For most duplex scanning apparatuses, the flatbed image scanning portion has one scanning module responsible for scanning both sides of the document. After scanned, the paper sheets are transferred to the discharging tray.

The duplex scanning operation performed by the duplex canning apparatus having one scanning module is also referred as a three-pass scanning operation. When the document is transported across the scan region for the first time, the scanning module scans a front side of the document. When the document is transported across the scan region for the second time, the scanning module scans a back side of the document. Finally, the document is transported across the scan region for the third time to rearrange each document into the same order as that of the original stack.

Referring to FIG. 1, a schematic cross-sectional view of a conventional duplex scanning apparatus having a single scanning module is illustrated. The process of performing the duplex scanning operation by the duplex scanning apparatus 100 of FIG. 1 will be illustrated as follows. First of all, a document 111 to be scanned is placed on a sheet feeding tray 102. The automatic document feeder 113 transports the document 111 into a first path 104. Then, the document 111 enters a scan region 107 through a second path 106. When the document is transported across the scan region 107, a scanning module 105 scans a front side of the document 111. Then, the document 111 is transported across a third path 108 and a guiding rod 109 to an inverting region 112. The guiding rod 109 is switched to a first position leading the document 111 to the inverting region 112. Next, the document 111 in the inverting region 112 is transported to a fourth path 110 through the guiding rod 109, and then transported to the scan region 107 through the second path 106. When the document 111 is transported across the scan region 107, the scanning module 105 scans a back side of the document 111. Then, the document 111 is transported across the third path 108 and the guiding rod 109 to the inverting region 112. Next, the document 111 in the inverting region 112 is transported across the guiding rod 109 to the fourth path 110, the second path 106, the scan region 107 and third path 108. When the document passes through the scan region 107 for the third time, the scanning module 105 does not scan the document 111. Finally, the guiding rod 109 is switched to the second position, thereby leading the document 111 to the discharging tray 103.

As previously described, the top paper sheet from a stack of paper sheets is transported across the scan region for two times to scan the front and back sides thereof, and is then transported across the scan region for the third time to rearrange each document into the same order as that of the original stack. Since the document is transported across the scan region for three times, such a three-pass scanning operation is time-consuming and has reduced working speed. In addition, since the inverting region 112 is disposed at a relatively high level with respect to the flatbed image scanning portion 101, the height of the sheet feeding tray 102 or the overall volume of the duplex scanning apparatus is increased. In other words, the operative space of the duplex scanning apparatus is large.

For overcoming the above problems, another duplex scanning apparatus having two scanning modules is developed. The duplex scanning operation performed by the duplex canning apparatus having two scanning modules is also referred as a one-pass scanning operation. When the document is transported across the scan region, the two scanning modules simultaneously scan front and back sides of the document. In other words, the document needs to pass through the scan region for only one time to perform the duplex scanning operation. In comparison with the duplex canning apparatus having one scanning module, the second type of duplex scanning apparatus has an increased scanning speed. However, the duplex scanning apparatus having two scanning module is costly.

Therefore, there is a need for providing an improved duplex scanning apparatus having reduced operative space and cost-effectiveness.

In views of the above-described disadvantages resulted from the prior art, the applicant keeps on carving unflaggingly to develop a duplex scanning apparatus according to the present invention through wholehearted experience and research.

### SUMMARY OF THE INVENTION

It is an object of the present invention to provide a duplex scanning apparatus for performing a two-pass scanning operation, in which the scanned documents are stacked in the discharging tray in the same order as that of the original stack.

In accordance with an aspect of the present invention, there is provided a duplex scanning apparatus. The duplex scanning apparatus includes a flatbed image scanning portion, a sheet feeding tray, a sheet pick-up roller, a sheet separation roller, a first discharging tray, a second discharging tray, a feeding path, an input path, a first discharging path, a first discharging roller assembly, an inverting path, a second discharging path, a second discharging roller assembly and a third discharging roller assembly. The flatbed image scanning portion includes a scanning module for scanning a document in a scan region. The sheet feeding tray is used for placing therein the document to be scanned, wherein the sheet feeding tray includes a first opening and a second opening. The sheet pick-up roller is partially received in the first opening of the sheet feeding tray to be sustained against the document. The sheet separation roller is partially received in the second opening of the sheet feeding tray to be sustained against the document. The first discharging tray is used for supporting the document. The second discharging tray is used for supporting the document. The feeding path is arranged between the second discharging tray and a second transfer roller assembly and passes through the scan region. The input path is arranged between the sheet feeding tray and the feeding path. The first discharging path is arranged between the feeding path and the first discharging tray. The first discharging roller assembly is disposed at the feeding path and proximate the first discharging tray for continuously transporting the document in the feeding path or transporting the document into the first discharging path. The inverting path is arranged between the second transfer roller assembly and the second discharging tray. The second discharging path is disposed above the inverting path arranged and between the second transfer roller assembly and the second discharging tray. The second discharging roller assembly is disposed at the inverting path and proximate the second discharging tray for transporting the document from the inverting path into the second discharging tray or transporting the document from the second discharging tray into the feeding path. The third discharging roller assembly is disposed at the second discharging path and proximate the second discharging tray for transporting the document to the second discharging tray.

In an embodiment, the second discharging roller assembly comprises a driving roller and an inverting follower roller. The driving roller is used for transporting the document from the inverting path into the second discharging tray or transporting the document from the second discharging tray into the feeding path by changing the rotational direction thereof.

In an embodiment, the third discharging roller assembly comprises the driving roller and an discharging follower roller.

In an embodiment, the duplex scanning apparatus further comprises a first transfer roller assembly disposed at the feeding path and proximate the input path.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view of a conventional duplex scanning apparatus having a single scanning module; and

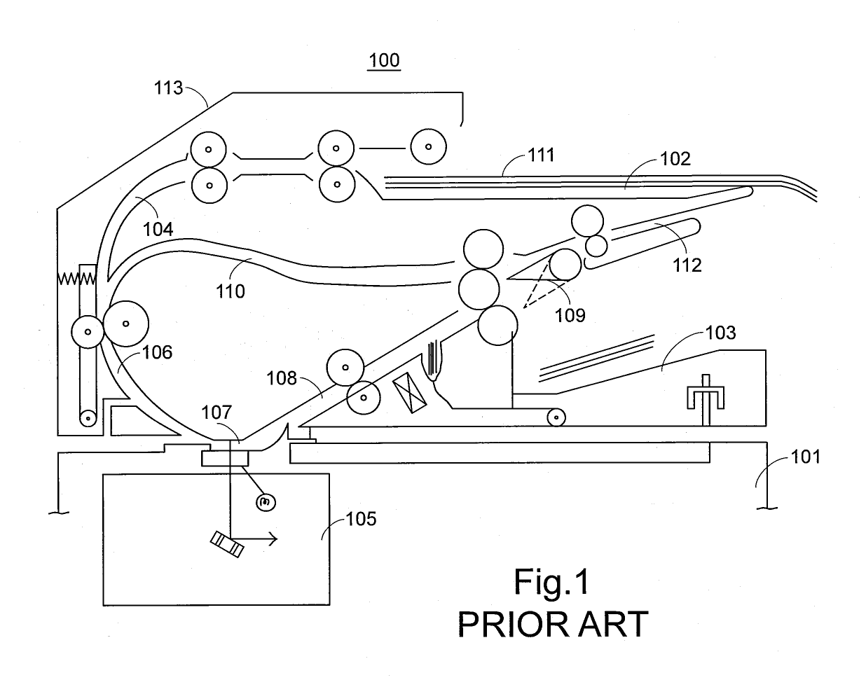

FIG. 2 is a schematic cross-sectional view of a duplex scanning apparatus according to a preferred embodiment of the present invention.

### DETAILED DESCRIPTION OF THE PREFERRED EMBODIMENT

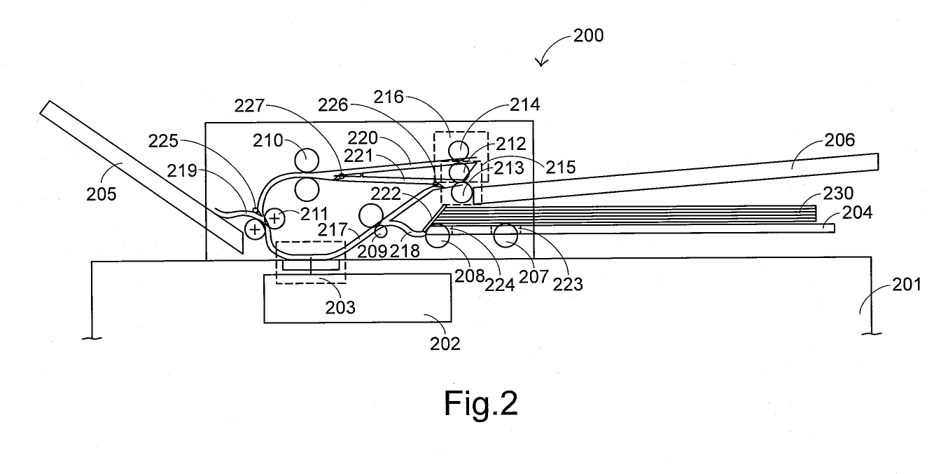

Referring to FIG. 2, a schematic cross-sectional view of a duplex scanning apparatus according to a preferred embodiment of the present invention is illustrated. The duplex scanning apparatus 200 as shown in FIG. 2 comprises a flatbed image scanning portion 201, a scanning module 202, a sheet feeding tray 204, a first discharging tray 205, a second discharging tray 206, a sheet pick-up roller 207, a sheet separation roller 208, a first transfer roller assembly 209, a second transfer roller assembly 210, a first discharging roller assembly 211, a second discharging roller assembly 215, a third discharging roller assembly 216, a feeding path 217, an input path 218, a first discharging path 219, a second discharging path 220, an inverting path 221, a frictional separation strip 222, a first discharge guiding rod 225, an inverting guiding rod 226 and a second discharge guiding rod 227. The sheet feeding tray 204 further includes a first opening 223 and a second opening 224. The sheet pick-up roller 207 and the sheet separation roller 208 are partially received in the first opening 223 and the second opening 224, respectively, so that the documents on the sheet feeding tray 204 are sustained against the sheet pick-up roller 207 and the sheet separation roller 208. The second discharging roller assembly 215 includes a driving roller 212 and an inverting follower roller 213. The third discharging roller assembly 216 includes the driving roller 212 and an discharging follower roller 214.

The first discharge guiding rod 225 is switched between a first position leading the document to the feeding path 217 and a second position leading the document to the first discharging path 219. The inverting guiding rod 226 is switched between a first position leading the document to the feeding path 217 and a second position leading the document to the inverting path 221. The second discharge guiding rod 227 is switched between a first position leading the document to the second discharging path 220 and a second position leading the document to the inverting path 221. The frictional separation strip 222 is responsible for offering a frictional force to transport the document. In addition, due to the frictional separation strip 222, only the document in direct contact with the sheet pick-up roller 207 and the sheet separation roller 208 is allowed to transport the feeding document into the input path 218, but the other documents are hindered from being transported to the input path 218.

As previously described, the conventional duplex scanning apparatus transports and scans the top paper sheet from the stack of paper sheets. In contrast, the duplex scanning apparatus of the present invention transports and scans the bottom paper sheet from the stack of paper sheets 230. That is, for performing duplex scanning operations on the stack of paper sheets, the documents are successively scanned from the bottommost paper sheet to the uppermost paper sheet. For each paper sheet, the bottom side thereof is firstly scanned and then the top side thereof is scanned.

Please refer to FIG. 2 again. Hereinafter, the procedure of performing a single-side scanning operation by the duplex scanning apparatus 200 is illustrated. First of all, the documents 230 to be scanned are placed on the sheet feeding tray 204 such that the sheet pick-up roller 207 and the sheet separation roller 208 are sustained against the documents 230. Then, the sheet pick-up roller 207 transports a first document 230 into the feeding path 217 through the input path 218. Then, the first transfer roller assembly 209 transports the document 230 to the scan region 203. When the document 230 is transported across the scan region 203, the scanning module 202 scans the document 230. Next, the first discharge guiding rod 225 is switched to the second position leading the document to the first discharging path 219, and the first discharging roller assembly 211 is rotated to transport the document 230 across the first discharging path 219 to the first discharging tray 205. Meanwhile, the bottom side of the first document 230 has implemented the single-side scanning operation. The remainder documents 230 on the sheet feeding tray 204 successively implement the single-side scanning operations identical to that for the first document 230. As a consequence, the documents 230 are stacked in the first discharging tray 205 in the same order as that of the original stack.

Please refer to FIG. 2 again. Hereinafter, the procedure of performing a duplex scanning operation by the duplex scanning apparatus 200 is illustrated. First of all, the documents 230 to be scanned are placed on the sheet feeding tray 204 such that the sheet pick-up roller 207 and the sheet separation roller 208 are sustained against the documents 230. By the sheet pick-up roller 207, the sheet separation roller 208 and the frictional separation strip 222, the first document 230 is transported into the feeding path 217 through the input path 218. Then, the first transfer roller assembly 209 transports the document 230 to the scan region 203. When the document 230 is transported across the scan region 203, the scanning module 202 scans a first side of the document 230. Next, the first discharge guiding rod 225 is maintained at the second position leading the document to the feeding path 217, and the first discharging path 219 is closed. Next, the second discharge guiding rod 227 is switched to second position leading the document 230 to the inverting path 221, and the second discharging path 220 is closed. Meanwhile, the second transfer roller assembly 210 transports the document 230 through the inverting path 221. Next, the inverting guiding rod 226 is switched to close the feeding path 217, and the driving roller 212 of the second discharging roller assembly 215 is rotated anti-clockwise to transport the document 230 to the second discharging tray 206. Meanwhile, the first side of the document 230 has been scanned.

After the majority of the document 230 has entered the second discharging tray 206, the inverting guiding rod 226 is switched to close the inverting path 221 and the driving roller 212 of the second discharging roller assembly 215 is rotated clockwise to transport the document 230 from the second discharging tray 206 to the feeding path 217. Then, the first transfer roller assembly 209 transports the document 230 into the scan region 203. When the document 230 is transported across the scan region 203, the scanning module 202 scans a second side of the document 230. The first discharge guiding rod 225 is maintained at the second position leading the document to the feeding path 217. The first discharging roller assembly 211 is rotated to transport the document 230 across the first feeding path 217. Next, the second discharge guiding rod 227 is switched to the first position leading the document 230 to second discharging path 220, and the second transfer roller assembly 210 transports the document 230 through the second discharging path 220. Next, the third discharging roller assembly 216 transports the document 230 to the second discharging tray 206. The remainder documents 230 on the sheet feeding tray 204 successively implement the duplex scanning operations identical to that for the first document 230. As a consequence, the documents 230 are stacked in the second discharging tray 206 in the same order as that of the original stack.

Especially, for performing duplex scanning operations on the stack of paper sheets, the documents are successively scanned from the bottommost paper sheet to the uppermost paper sheet. The frictional forces resulted from the document, the frictional separation strip and the roller should be elaborately controlled. It is preferred that the frictional force u3 between the document and the roller is greater than the frictional force u1 between the document and the frictional separation strip, and the frictional force u1 is greater than the frictional force u2 between the documents.

From the above description, when the duplex scanning apparatus of the present invention performs the duplex scanning operation, the document needs to pass through the scan region for two times. That is, the duplex scanning operation by the present invention can be referred as a two-pass scanning operation. In comparison with the conventional three-pass scanning operation, the number of transporting the document through the scan region is reduced. Consequently, the time period of performing the duplex scanning operation is shortened.

In addition to the function of discharging the document, the second discharging tray 206 is also served as an inverting region. As a consequence, the operative space for accommodating the inverting region as described in the prior art is saved, and the length and the overall volume thereof are reduced. Since the paths for transporting the documents are specially designed, the number of the rollers is reduced. As a consequence, the rollers have increased reliability and durability, so that the shelf life of the duplex scanning apparatus is extended. For example, the reliability of an A-type roller is 0.95 and the reliability of a B-type roller is 0.90. In a case that the duplex scanning apparatus has one A-type roller and four B-type rollers, the reliability of this duplex scanning apparatus is 0.623295 (=0.95×0.9×0.9×0.9×0.9). In another case that the duplex scanning apparatus has one A-type roller and one B-type roller, the reliability of this duplex scanning apparatus is 0.855 (=0.95×0.9). That is, as the number of the rollers is decreased, the reliability and the shelf life of the duplex scanning apparatus are increased. Moreover, since the number of the rollers is decreased, the duplex scanning apparatus is more cost-effective.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A duplex scanning apparatus comprising:
a flatbed image scanning portion including a scanning module for scanning a document in a scan region;
a sheet feeding tray for placing therein said document to be scanned, wherein said sheet feeding tray includes a first opening and a second opening;
a sheet pick-up roller partially received in said first opening of said sheet feeding tray to be sustained against said document;
a sheet separation roller partially received in said second opening of said sheet feeding tray to be sustained against said document;
a first discharging tray for supporting said document;
a second discharging tray for supporting said document;
a feeding path arranged between said second discharging tray and a second transfer roller assembly and passing through said scan region;
an input path arranged between said sheet feeding tray and said feeding path;
a first discharging path arranged between said feeding path and said first discharging tray;
a first discharging roller assembly disposed at said feeding path and proximate said first discharging tray for continuously transporting said document in said feeding path or transporting said document into said first discharging path;
an inverting path arranged between said second transfer roller assembly and said second discharging tray;
a second discharging path disposed above said inverting path arranged and between said second transfer roller assembly and said second discharging tray;
a second discharging roller assembly disposed at said inverting path and proximate said second discharging tray for transporting said document from said inverting path into said second discharging tray or transporting said document from said second discharging tray into said feeding path; and
a third discharging roller assembly disposed at said second discharging path and proximate said second discharging tray for transporting said document to said second discharging tray.

2. The duplex scanning apparatus according to claim 1 wherein said second discharging roller assembly comprises:
a driving roller for transporting said document from said inverting path into said second discharging tray or transporting said document from said second discharging tray into said feeding path by changing the rotational direction thereof; and
an inverting follower roller.

3. The duplex scanning apparatus according to claim 2 wherein said third discharging roller assembly comprises said driving roller and an discharging follower roller.

4. The duplex scanning apparatus according to claim 1 further comprising a first transfer roller assembly disposed at said feeding path and proximate said input path.
